(19) United States
(12) Patent Application Publication
(10) Pub. No.: US 2025/0269607 A1
(43) Pub. Date: Aug. 28, 2025

(54) METHOD FOR MANUFACTURING THREE-DIMENSIONAL SHAPED OBJECT

(71) Applicant: SEIKO EPSON CORPORATION, Tokyo (JP)

(72) Inventor: Hayato ASUKA, Shiojiri (JP)

(21) Appl. No.: 19/063,398

(22) Filed: Feb. 26, 2025

(30) Foreign Application Priority Data
Feb. 28, 2024 (JP) 2024-028241

(51) Int. Cl. B29C 64/40; B29C 64/336; B33Y 10/00

(52) U.S. Cl. CPC B29C 64/40; B29C 64/336; B33Y 10/00

(57) ABSTRACT

A method for manufacturing a three-dimensional shaped object includes: a first process of ejecting a first shaping material to shape a release layer on a stage; a second process of ejecting a second shaping material and stacking a shaped layer on the release layer to shape a main body part of a three-dimensional shaped object; and a third process of ejecting a third shaping material to shape a brim layer on the release layer, wherein the release layer and the brim layer are layers separated from the main body part shaped by the second process, and a corner part of the brim layer and an outline of the main body part come into contact with each other over a plurality of shaped layers.

The present application is based on, and claims priority from JP Application Serial Number 2024-028241, filed Feb. 28, 2024, the disclosure of which is hereby incorporated by reference herein in its entirety.

### BACKGROUND

### 1. Technical Field

The present disclosure relates to a method for manufacturing a three-dimensional shaped object.

### 2. Related Art

JP-A-2019-72943 discloses that, in order to suppress the occurrence of warping during the shaping of a three-dimensional shaped object, a circular brim is shaped in such a way as to be in contact with a site where the warping is expected to occur, of an outer perimeter of a shaping target layer.

JP-A-2019-72943 is an example of the related art.

When the area of the brim is increased according to the shape of the three-dimensional shaped object, the warping of the three-dimensional shaped object may not be able to be sufficiently suppressed, due to the deformation of the brim itself.

### SUMMARY

According to a first aspect of the present disclosure, a method for manufacturing a three-dimensional shaped object is provided. This manufacturing method includes: a first process of ejecting a first shaping material to shape a release layer on a stage; a second process of ejecting a second shaping material and stacking a shaped layer on the release layer to shape a main body part of a three-dimensional shaped object; and a third process of ejecting a third shaping material to shape a brim layer on the release layer, wherein the release layer and the brim layer are layers separated from the main body part shaped by the second process, and a corner part of the brim layer and the main body part come into contact with each other over a plurality of shaped layers.

### BRIEF DESCRIPTION OF THE DRAWINGS

FIG. 1 is a view illustrating a schematic configuration of a three-dimensional shaping device.

FIG. 2 is a perspective view illustrating a schematic configuration of a flat screw.

FIG. 3 is a schematic plan view of a barrel.

FIG. 4 is a view schematically showing a basic operation of the three-dimensional shaping device.

FIG. 5 is a flowchart of three-dimensional shaping processing.

FIG. 6 is a perspective view of a main body part.

FIG. 7 is a side view of the main body part.

FIG. 8 is a perspective view showing a state where the manufacture of a three-dimensional shaped object is underway.

FIG. 9 is a diagram showing a result of evaluation of the amount of warping of the main body part.

FIG. 10 is a perspective view showing the form of a sample 2.

FIG. 11 is a perspective view showing the form of a sample 3.

FIG. 12 is a perspective view showing the form of a sample 4.

FIG. 13 is a perspective view showing the form of a sample 5.

FIG. 14 is a perspective view showing the form of a sample 6.

### DESCRIPTION OF EMBODIMENTS

### A. First Embodiment

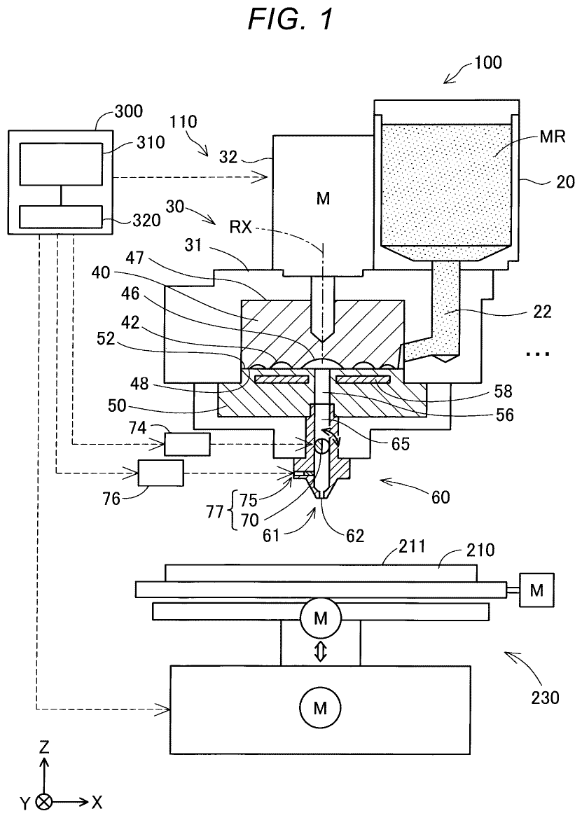

FIG. 1 is a view illustrating a schematic configuration of a three-dimensional shaping device 100 according to a first embodiment. In FIG. 1, arrows indicating X, Y, and Z directions orthogonal to one another are shown. The X direction and the Y direction are directions parallel to a horizontal plane, and the Z direction is a direction along a vertically upward direction. The arrows s indicating the X, Y, and Z directions are illustrated as appropriate in other drawings as well in such a way that the illustrated directions correspond to those in FIG. 1. In the description below, to specify a direction, a direction indicated by an arrow in the drawings is defined as “+” and a direction opposite to that direction is defined as “−”, and the positive and negative signs are also used in the representation of directions. In the description below, a +Z direction is also referred to as “up”, and a −Z direction is also referred to as “down”.

The three-dimensional shaping device 100 according to the present embodiment is a device that shapes a three-dimensional shaped object by a material extrusion method. The three-dimensional shaping device 100 includes a shaping unit 110 that generates and ejects a shaping material, a stage 210 for shaping that serves as a base for the three-dimensional shaped object, a movement mechanism 230 that controls an ejection position of the shaping material, and a control unit 300 that controls each part of the three-dimensional shaping device 100. Although one shaping unit 110 is shown in FIG. 1, in the embodiment, a plurality of shaping units 110 that generates and ejects different shaping materials is provided in the three-dimensional shaping device 100. The configurations of the shaping units 110 are the same.

The shaping unit 110 ejects a shaping material formed by plasticizing a solid-state material onto the stage 210 under the control of the control unit 300. The shaping unit 110 includes a material supply unit 20 which is a supply source of a raw material before being converted into the shaping material, a plasticizing unit 30 which converts the raw material into the shaping material, and an ejection unit 60 which ejects the shaping material.

The material supply unit 20 supplies a raw material MR to the plasticizing unit 30. The material supply unit 20 is configured with, for example, a hopper that accommodates the raw material MR. The material supply unit 20 is coupled to the plasticizing unit 30 via a communication path 22. The raw material MR is put in the material supply unit 20 in the form of pellets, powder, or the like. As the raw material MR, a resin material such as acrylonitrile butadiene styrene (ABS), polyetherether ketone (PEEK), or polypropylene (PP) is used. The raw material MR may contain an inorganic material such as metal or ceramic.

The plasticizing unit 30 plasticizes the raw material MR supplied from the material supply unit 20, thus generates a paste-like shaping material exhibiting fluidity, and guides the shaping material to the ejection unit 60. In the embodiment, the term “plasticize” refers to a concept including melting and means changing a solid state to a fluid state. Specifically, in the case of a material in which glass transition occurs, plasticizing means setting the temperature of the material to be equal to or higher than the glass transition point. In the case of a material in which glass transition does not occur, plasticizing means setting the temperature of the material to be equal to or higher than the melting point.

The plasticizing unit 30 includes a screw case 31, a drive motor 32, a flat screw 40, and a barrel 50. The flat screw 40 is also referred to as a rotor or a scroll. The barrel 50 is also referred to as a screw-facing part.

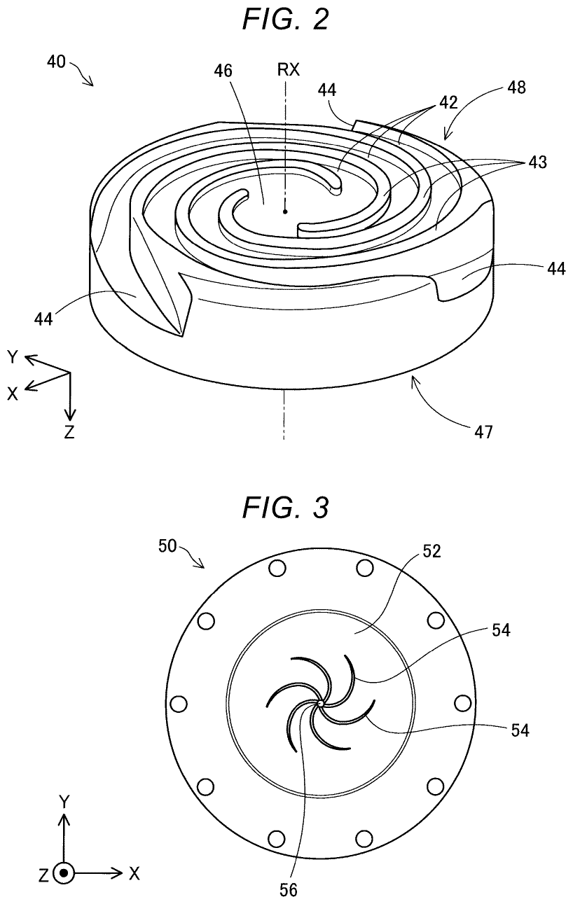

FIG. 2 is a perspective view illustrating a schematic configuration on the side of a lower surface 48 of the flat screw 40. To facilitate the understanding of the technique, the flat screw 40 illustrated in FIG. 2 is illustrated in a state where the positional relationship between an upper surface 47 and the lower surface 48 illustrated in FIG. 1 is reversed in the vertical direction. FIG. 3 is a schematic plan view showing the side of an upper surface 52 of the barrel 50. The flat screw 40 has a substantially cylindrical shape whose length in an axial direction that is a direction along a central axis thereof is shorter than the length in a direction perpendicular to the axial direction. The flat screw 40 is disposed in such a way that a rotation axis RX that is a rotation center thereof is parallel to the Z direction.

As shown in FIG. 1, the flat screw 40 is housed in the screw case 31. The upper surface 47 of the flat screw 40 is coupled to the drive motor 32, and the flat screw 40 rotates in the screw case 31 due to a rotational driving force generated by the drive motor 32. The drive motor 32 is driven under the control of the control unit 300. The flat screw 40 may be driven by the drive motor 32 via a decelerator.

As shown in FIG. 2, grooves 42 in a vortex shape are formed in the lower surface 48, which is a surface intersecting the rotation axis RX, of the flat screw 40. The communication path 22 of the material supply unit 20 communicates with the grooves 42 from the side surface of the flat screw 40. In the embodiment, three grooves 42 are formed, separated from each other by protruding parts 43. The number of the grooves 42 is not limited to three and may be one or may be two or more. The grooves 42 are not limited to the vortex shape and may have a spiral shape or an involute curve shape, or may have a shape extending arcuately from the central part toward the outer circumference.

The lower surface 48 of the flat screw 40 faces the upper surface 52 of the barrel 50, and a space is formed between the grooves 42 in the lower surface 48 of the flat screw 40 and the upper surface 52 of the barrel 50. The raw material MR is supplied into the space between the flat screw 40 and the barrel 50 from the material supply unit 20 through material inlets 44 illustrated in FIG. 2.

As shown in FIG. 1, a barrel heater 58 for heating the raw material MR supplied into the grooves 42 of the rotating flat screw 40 is embedded in the barrel 50. A communication hole 56 is provided at the center of the barrel 50. As shown in FIG. 3, a plurality of guide grooves 54 coupled to the communication hole 56 and extending in a vortex shape from the communication hole 56 toward the outer circumference is formed in the upper surface 52 of the barrel 50. One end of each of the guide grooves 54 may not be coupled to the communication hole 56. The guide grooves 54 may be omitted.

The raw material MR supplied into the grooves 42 of the flat screw 40 flows along the grooves 42 due to the rotation of the flat screw 40 while being plasticized in the grooves 42, and is guided to a central part 46 of the flat screw 40 as the shaping material. The paste-like shaping material exhibiting fluidity, which flows into the central part 46, is supplied to the ejection unit 60 via the communication hole 56 provided at the center of the barrel 50. In the shaping material, not all the kinds of substances forming the shaping material may be plasticized. The shaping material may be converted into a fluid state as a whole by plasticizing at least a part of the kinds of substances forming the shaping material.

The ejection unit 60 illustrated in FIG. 1 includes a nozzle 61 that ejects the shaping material, a flow path 65 for the shaping material that is formed between the flat screw 40 and a nozzle opening 62, and an ejection control unit 77 that controls the ejection of the shaping material.

The nozzle 61 is coupled to the communication hole 56 of the barrel 50 through the flow path 65. The nozzle 61 ejects the shaping material generated by the plasticizing unit 30, from the nozzle opening 62 at the distal end toward the stage 210.

The ejection control unit 77 includes an ejection adjustment unit 70 that opens and closes the flow path 65 and a suction unit 75 that suctions and temporarily stores the shaping material.

The ejection adjustment unit 70 is provided in the flow path 65 and changes the opening degree of the flow path 65 by rotating in the flow path 65. In the embodiment, the ejection adjustment unit 70 is configured with a valve. The ejection adjustment unit 70 is driven by a first drive unit 74 under the control of the control unit 300. The first drive unit 74 is configured with, for example, a stepping motor. The control unit 300 controls the rotation angle of the valve, using the first drive unit 74, and thus can adjust the flow rate of the shaping material flowing from the plasticizing unit 30 to the nozzle 61, that is, the amount of ejection of the shaping material ejected from the nozzle 61. The ejection adjustment unit 70 can adjust the amount of ejection of the shaping material and can control the ON and OFF of the outflow of the shaping material.

The suction unit 75 is coupled at a site between the ejection adjustment unit 70 and the nozzle opening 62 in the flow path 65. The suction unit 75 temporarily suctions the shaping material in the flow path 65 when the ejection of the shaping material from the nozzle 61 is stopped, and thereby suppresses a trailing phenomenon in which the shaping material hangs down like a string from the nozzle opening 62. In the embodiment, the suction unit 75 is configured with a plunger. The suction unit 75 is driven by a second drive unit 76 under the control of the control unit 300. The second drive unit 76 is configured with, for example, a stepping motor or a rack-and-pinion mechanism that converts a rotational force generated by the stepping motor into a translational motion of the plunger, or the like.

The stage 210 is disposed at a position facing the nozzle opening 62 of the nozzle 61. In the first embodiment, a shaping surface 211 of the stage 210 facing the nozzle opening 62 of the nozzle 61 is parallel to the X and Y directions, that is, a horizontal direction. The stage 210 may include a stage heater for suppressing sudden cooling of the shaping material ejected onto the stage 210.

The movement mechanism 230 changes the relative position between the stage 210 and the nozzle 61 under the control of the control unit 300. In the embodiment, the position of the nozzle 61 is fixed, and the movement mechanism 230 moves the stage 210. The movement mechanism 230 is configured with a three-axis positioner that moves the stage 210 in three axial directions, that is, the X, Y, and Z directions, by the driving forces of three motors. In the present specification, the movement of the nozzle 61 means moving the nozzle 61 or the ejection unit 60 relatively to the stage 210, unless stated otherwise.

In another embodiment, a configuration in which the movement mechanism 230 moves the nozzle 61 in relation to the stage 210 in the state where the position of the stage 210 is fixed may be employed instead of the configuration in which the movement mechanism 230 moves the stage 210. Also, a configuration in which the movement mechanism 230 moves the stage 210 in the Z direction and moves the nozzle 61 in the X and Y directions, or a configuration in which the movement mechanism 230 moves the stage 210 in the X and Y directions and moves the nozzle 61 in the Z direction may be employed. With these configurations, too, the relative positional relationship between the nozzle 61 and the stage 210 can be changed.

The control unit 300 is configured with a computer including one or a plurality of processors 310, a storage unit 320 made up of a main storage device and an auxiliary storage device, and an input/output interface for inputting and outputting a signal from and to outside. The processor 310 executes a program stored in the storage unit 320 to control the shaping unit 110 and the movement mechanism 230 according to shaping data stored in the storage unit 320, and thus shapes a three-dimensional shaped object on the stage 210. The shaping data for shaping the three-dimensional shaped object includes path information representing a movement path of the nozzle 61 and amount-of-ejection information representing the amount of ejection of the shaping material in each movement path, for each layer formed by slicing the shape of the three-dimensional shaped object into a plurality of parts. The movement path of the nozzle 61 is a path in which the nozzle 61 relatively moves along the shaping surface 211 of the stage 210 while ejecting the shaping material. The control unit 300 may be implemented by combining circuits together, instead of being configured with a computer.

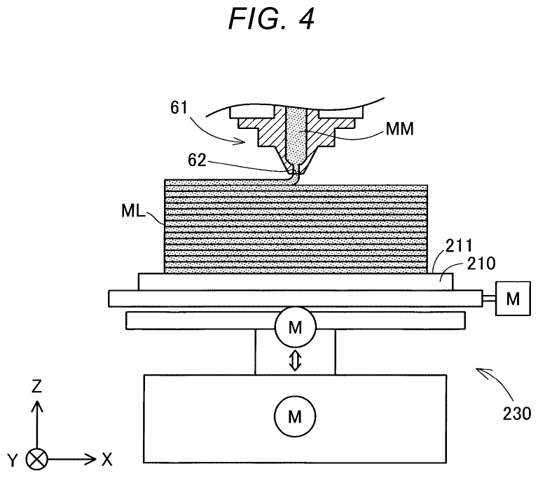

FIG. 4 is a view schematically illustrating the basic operation of the three-dimensional shaping device 100. As described above, in the three-dimensional shaping device 100, the solid-state raw material MR is plasticized to generate a shaping material MM. The control unit 300 causes the nozzle 61 to eject the shaping material MM while changing the position of the nozzle 61 in relation to the stage 210 in a direction along the shaping surface 211 of the stage 210, maintaining the distance between the shaping surface 211 of the stage 210 and the nozzle 61. The shaping material MM ejected from the nozzle 61 is continuously deposited in the direction of movement of the nozzle 61.

The control unit 300 repeats the movement of the nozzle 61 and thus forms shaped layers ML. After forming one shaped layer ML, the control unit 300 relatively moves the position of the nozzle 61 in relation to the stage 210 in the +Z direction, which is the stacking direction of the shaped layers ML. Then, the control unit 300 stacks another shaped layer ML on the already formed shaped layers ML and thus shapes the three-dimensional shaped object.

For example, when the nozzle 61 is moved in the Z direction on completion of one shaped layer ML or when there is a plurality of independent shaping regions in each shaped layer, the control unit 300 may temporarily suspend the ejection of the shaping material from the nozzle 61. In this case, the flow path 65 is closed by the ejection adjustment unit 70, the ejection of the shaping material MM from the nozzle opening 62 is stopped, and the shaping material in the nozzle 61 is temporarily suctioned by the suction unit 75. After changing the position of the nozzle 61, the control unit 300 discharges the shaping material from inside the suction unit 75 and opens the flow path 65 by the ejection adjustment unit 70, and thus resumes the deposition of the shaping material MM from the changed position of the nozzle 61.

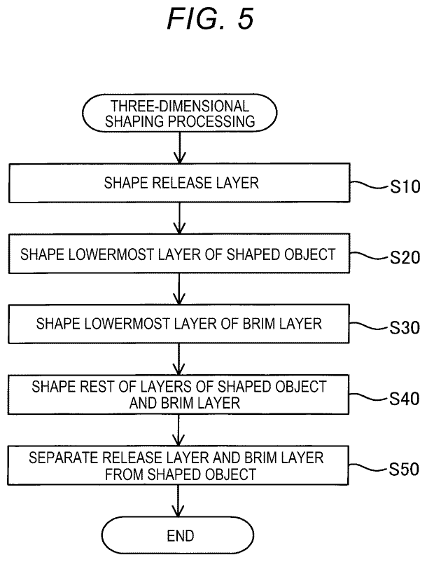

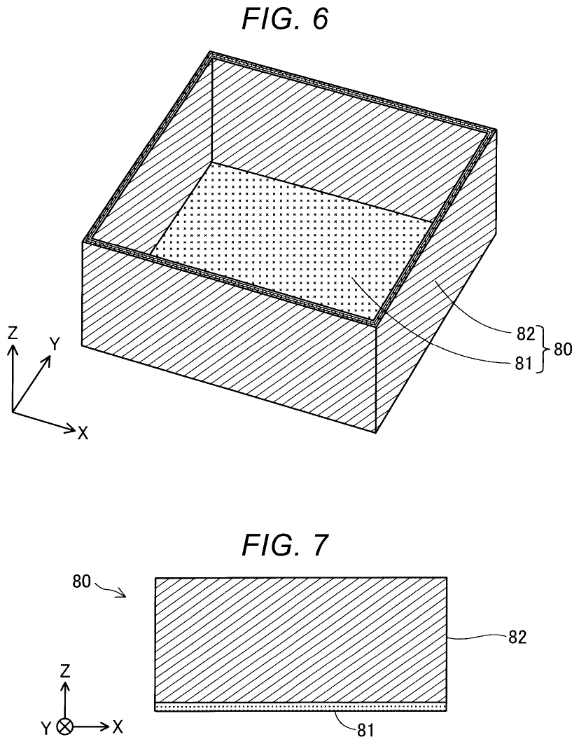

FIG. 5 is a flowchart of three-dimensional shaping processing executed by the control unit 300. As the three-dimensional shaping processing shown in FIG. 5 is executed, a method of manufacturing a three-dimensional shaped object is implemented. FIG. 6 is a perspective view of a main body part 80 of the three-dimensional shaped object shaped by the three-dimensional shaping processing. FIG. 7 is a side view of the main body part 80. FIGS. 6 and 7 show the hollow main body part 80 with an upper side open, as an example of the main body part 80 of the three-dimensional shaped object. The main body part 80 includes a rectangular bottom surface 81 and a cylindrical wall part 82 coupled to an outer circumferential part of the bottom surface 81 and extending upward. The outermost part of the main body part 80 in the horizontal direction is hereinafter referred to as an outline. The outline of the main body part 80 has a plurality of corner parts. In the present disclosure, the “corner part” refers to a part that is convex outward, and is not limited to a pointed corner, and includes a curved corner such as a rounded corner. For example, in the case of the cylindrical shape, the entire range of the side surface of the cylinder is equivalent to the corner part.

In step S10 in FIG. 5, the control unit 300 controls the shaping unit 110 that ejects a first shaping material and the movement mechanism 230 to shape a release layer on the shaping surface 211 of the stage 210. The release layer is a layer for enabling easy release of the main body part 80 and a brim layer 86, described later, from the stage 210. The release layer is also referred to as a “raft”. The first shaping material is, for example, PP.

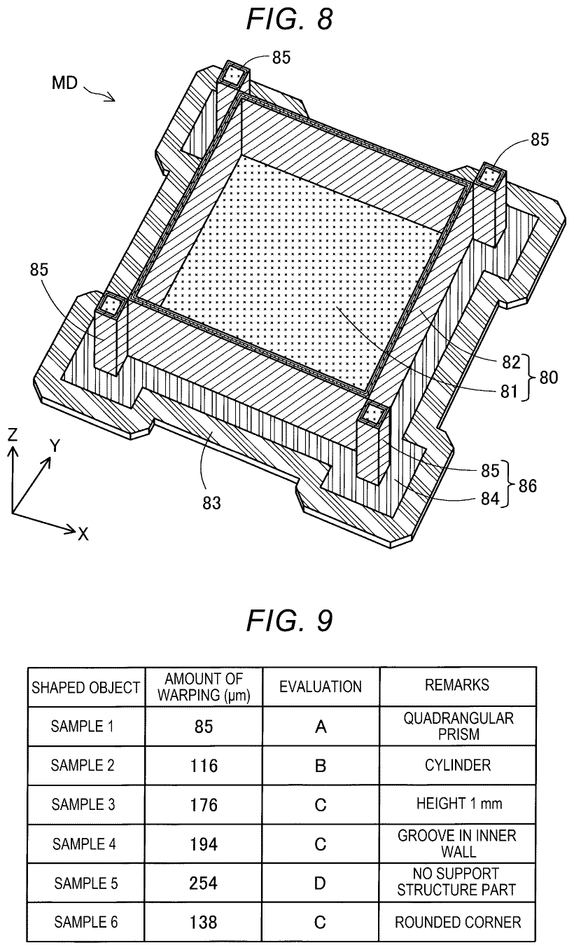

FIG. 8 is a perspective view showing a state where the manufacture of a three-dimensional shaped object MD is underway. FIG. 8 shows a state where a release layer 83 is shaped below the main body part 80. The area of the release layer 83 is larger than the area of the bottom surface 81 of the main body part 80. The number of layers forming the release layer 83 is, for example, 1 to 10, and can be freely designated by a user. The release layer 83 is used as a temporary stage. The data for shaping the release layer 83 may be included in the shaping data or may be generated by the control unit 300 analyzing the shaping data for shaping the main body part 80.

In step S20 shown in FIG. 5, the control unit 300 controls the shaping unit 110 that ejects a second shaping material and the movement mechanism 230 to shape a lowermost layer of the main body part 80 on the release layer 83 according to the shaping data. As shown in FIG. 8, the lowermost layer of the main body part 80 is a layer forming the bottom surface 81 of the main body part 80. The second shaping material is, for example, ABS. In the embodiment, the second shaping material is a material different from the first shaping material. That is, the release layer 83 and the main body part 80 are shaped with different shaping materials.

In step S30 illustrated in FIG. 5, the control unit 300 controls the shaping unit 110 that ejects a third shaping material and the movement mechanism 230 to form a lowermost layer of the brim layer 86 on the release layer 83. The brim layer 86 is a layer for suppressing the main body part 80 from coming off from the release layer 83.

As shown in FIG. 8, the control unit 300 shapes the lowermost layer of the brim layer 86 on the release layer 83. At this time, the control unit 300 forms the lowermost layer of the brim layer 86 in such a way as to be adjacent to the outline of the lowermost layer of the main body part 80. The expression “adjacent” means that the lowermost layer of the main body part 80 and the lowermost layer of the brim layer 86 are arranged adjacent to each other and in contact with each other. No brim layer 86 is formed below the main body part 80. When viewed from the +Z direction, the outer edge of the brim layer 86 is located between the outer perimeter of the lowermost layer of the main body part 80 and the outer perimeter of the release layer 83. The brim layer 86 has a plate-like part 84 and a support structure part 85. The lowermost layer of the brim layer 86 forms the plate-like part 84. The number of layers forming the plate-like part 84 is, for example, 1 to 10, and can be freely designated by a user. In the present embodiment, the support structure part 85 has a quadrangular prism shape. The data for shaping the brim layer 86 may be included in the shaping data or may be generated by the control unit 300 analyzing the shaping data for shaping the main body part 80.

In the present embodiment, the third shaping material used for shaping the brim layer 86 is the same material as the second shaping material used for shaping the main body part 80. Therefore, the shaping unit 110 that ejects the third shaping material is the same shaping unit 110 as the shaping unit 110 that ejects the second shaping material. Steps S20 and S30 may be in reverse order. That is, the lowermost layer of the brim layer 86 may be shaped before the lowermost layer of the main body part 80 is formed.

In step S40 in FIG. 5, the control unit 300 controls the shaping unit 110 and the movement mechanism 230 to shape the rest of the layers of the main body part 80, that is, the layers other than the lowermost layer of the main body part 80, and the rest of the layers of the brim layer 86, that is, the layers other than the lowermost layer of the brim layer 86. In step S40, the control unit 300 shapes the brim layer 86 in such a way as to be in contact with the main body part 80 over the plurality of shaped layers ML. Also, the control unit 300 shapes the brim layer 86 in such a way that the corner part of the side surface of the support structure part 85 comes into contact with the corner part of the outline of the main body part 80. That is, the control unit 300 shapes the brim layer 86 in such a way that the support structure part 85 and the main body part 80 are in line contact with each other. In the first embodiment, the control unit 300 shapes the support structure parts 85 separated from each other at positions corresponding to the plurality of corner parts of the outline of the main body part 80. Also, the control unit 300 shapes the support structure part 85 having a height corresponding to the height of the corner part of the main body part 80. Specifically, in the present embodiment, the support structure part 85 having the same height as the corner part of the main body part 80 is shaped. In the present disclosure, the “height corresponding to the height of the corner part of the main body part 80” means a height within a range of +10% with respect to the height of the corner part of the main body part 80.

In step S50 in FIG. 5, the release layer 83 and the brim layer 86 are separated from the main body part 80 shaped by the processes of steps S20 and S40. The separation process of step S50 is performed manually or by a cutting device. The main body part 80 of the three-dimensional shaped object is thus manufactured by the series of processes described above. Step S10 described above is also referred to as a “first process”. Steps S20 and S40 are also referred to as a “second process”. Steps S30 and S40 are also referred to as a “third process”.

According to the first embodiment described above, the main body part 80 of the three-dimensional shaped object MD and the corner part of the brim layer 86, more specifically, the corner part of the support structure part 85, come into contact with each other over the plurality of shaped layers ML, and therefore the occurrence of warping of the main body part 80 can be suppressed effectively. In particular, in the present embodiment, the support structure parts 85, which are separated from each other, are shaped at positions corresponding to the plurality of corner parts of the outline of the main body part 80, and therefore the occurrence of warping of the main body part 80 can be suppressed more effectively.

Also, in the present embodiment, the support structure part 85 has a quadrangular prism shape, and the corner part of the side surface of the support structure part 85 comes into contact with the corner part of the outline of the main body part 80. Therefore, the contact area between the main body part 80 and the brim layer 86 is reduced. Thus, the brim layer 86 can be easily released from the main body part 80 while the influence of the brim layer 86 on the appearance of the main body part 80 is suppressed.

Also, in the present embodiment, the height of the support structure part 85 is a height corresponding to the height of the corner part of the main body part 80, and therefore the occurrence of warping of the main body part 80 can be suppressed effectively. The height of the support structure part 85 is preferably 5% or more of the height of the corner part of the main body part 80, and more preferably the same as the height of the corner part of the main body part 80.

Also, in the present embodiment, since the main body part 80 and the brim layer 86 are formed of the same shaping material, even when there is a risk of the main body part 80 coming off from the release layer 83 during the shaping due to the difference in the shrinkage rate between the main body part 80 and the release layer 83, the contact area of the main body part 80 with the release layer 83 substantially increases and the degree of adhesion of the main body part 80 to the release layer 83 can thus be increased. Also, since the main body part 80 and the brim layer 86 are formed of the same shaping material, the separation of the main body part 80 from the brim layer 86 during the shaping or the occurrence of distortion due to the difference in the material at the boundary part between the brim layer 86 and the main body part 80 can be suppressed.

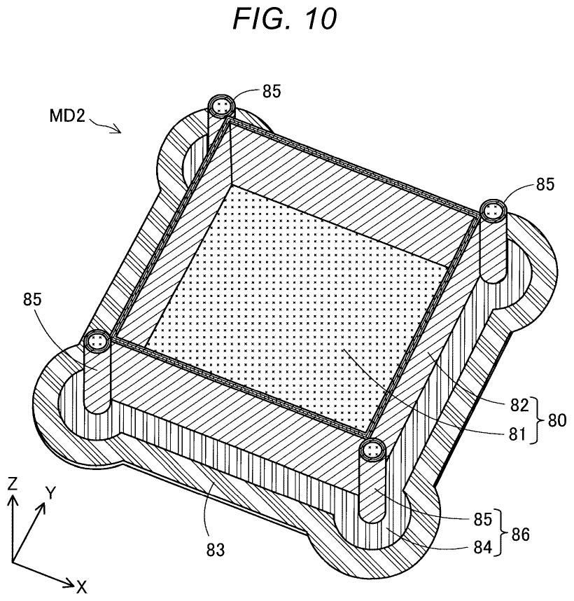

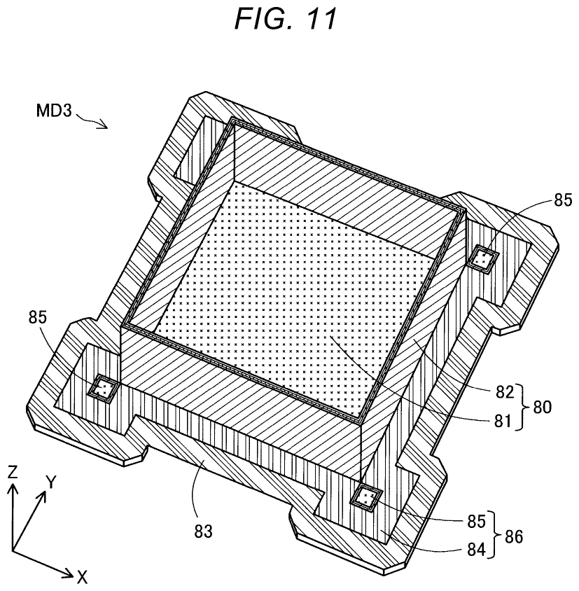

FIG. 9 is a diagram illustrating the result of evaluation of the amount of warping of the main body part 80. FIG. 9 shows the result of measuring the amount of warping of the bottom surface 81 of the main body part 80 for each of the samples of shaped objects in various forms. The main body part 80 of each sample has the same shape as the main body part 80 shown in FIG. 6 except for the sample 4 and the sample 6, and has dimensions of 50 mm in the X direction, 50 mm in the Y direction, and 20 mm in the Z direction. PP talc is used as the material of each sample. The amount of warping of the bottom surface 81 of each sample is calculated by measuring the difference between the height of an uppermost protruding part of the bottom surface 81 and the height of a lowermost recessed part of the bottom surface 81. In the results of evaluation shown in FIG. 9, “A” indicates the highest evaluation and “D” indicates the lowest evaluation.

Similarly to the three-dimensional shaped object MD illustrated in FIG. 8, the sample 1 is a sample in which the brim layer 86 including the support structure part 85 having a quadrangular prism shape is shaped. The height of the support structure part 85 is 20 mm, which is the same as the height of the shaped object. The amount of warping of the sample 1 is 85 μm, which is the smallest amount of warping.

FIG. 10 is a perspective view showing the form of a three-dimensional shaped object MD2 of the sample 2. The sample 2 is a sample in which the brim layer 86 including the support structure part 85 in a cylindrical shape is shaped. The height of the support structure part 85 is 20 mm, which is the same as the height of the shaped object. The amount of warping of the sample 2 is 116 μm, which is larger than that of the sample 1.

FIG. 11 is a perspective view showing the form of a three-dimensional shaped object MD3 of the sample 3. The sample 3 is a sample in which the brim layer 86 including the support structure part 85 in the shape of a quadrangular prism is shaped. The height of the support structure part 85 is 1 mm, which is 5% of the height of the main body part 80. The amount of warping of the sample 3 is 176 μm, which is larger than that of each of the samples 1 and 2.

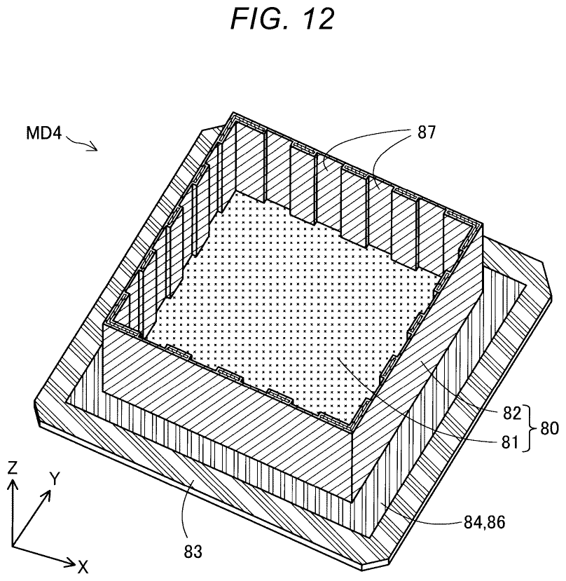

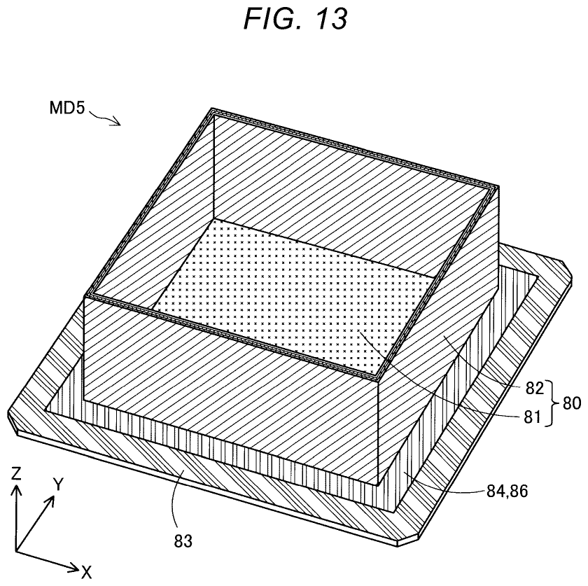

FIG. 12 is a perspective view showing the form of a three-dimensional shaped object MD4 of the sample 4. The sample 4 is a sample in which a plurality of grooves 87 is formed along the Z direction, which is the stacking direction of the shaped layers ML, on the inner surface of the main body part 80 having a hollow shape. The brim layer 86 of the sample 4 does not have the support structure part 85. The amount of warping of the sample 4 is 194 μm, which is approximately the same as that of the sample 3. The shape of the main body part 80 in the sample 4 is equivalent to a shape formed by shaping the main body part and the brim layer in such a way that the corner parts of the plurality of support structure parts come into contact with the flat inner surface of the main body part. Therefore, it is expected that a warping suppression effect similar to that of the sample 4 can be achieved even when the brim layer 86 including the support structure part in contact with the inner surface of the main body part 80 is formed. Although the support structure part 85 is not shaped in the sample 4, the support structure part 85 in contact with the corner part of the outline of the main body part 80 may be shaped as in the samples 1 to 3.

FIG. 13 is a perspective view showing the form of a three-dimensional shaped object MD5 of the sample 5. The sample 5 has a configuration in which the support structure part 85 is omitted from the three-dimensional shaped object MD illustrated in FIG. 8. The amount of warping of the sample 5 is 254 μm, which is the largest amount of warping among the samples 1 to 6.

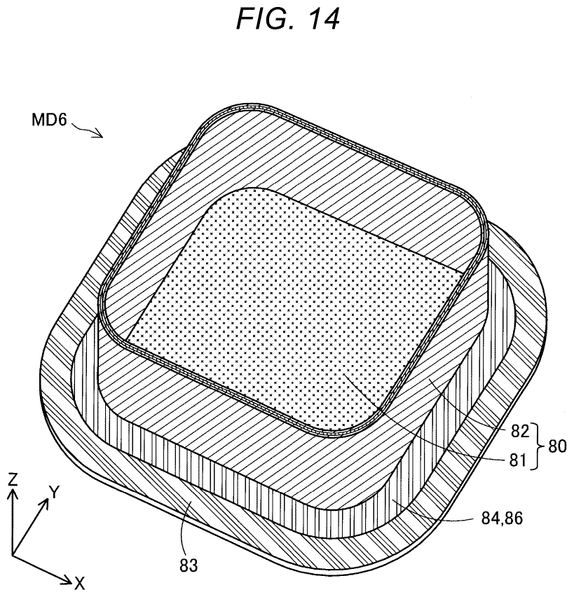

FIG. 14 is a perspective view showing the form of a three-dimensional shaped object MD6 of the sample 6. The sample 6 is a sample in which the brim layer 86 that does not include the support structure part 85 is shaped. In the sample 6, the shape of the main body part 80 itself is modified and a rounded corner with a radius of 10 mm (that is, 10R) is formed at the corner part. The control unit 300 modifies the shaping data for shaping the main body part 80 and thus forms the rounded corner at the corner part of the main body part 80. Thus, the amount of warping equivalent to that of each of the samples 3 and 4 is achieved by changing the shape of the main body part 80 itself.

According to the results of evaluation of each of the samples described above, it is confirmed that the warping of the main body part 80 of the three-dimensional shaped object can be suppressed by shaping the brim layer 86 including the support structure part 85 in contact with the main body part 80 at the corner part.

### B. Other Embodiments

(B1) In the above-described embodiment, the support structure part 85 provided in the brim layer 86 is in contact with the corner part of the outline of the main body part 80. However, the support structure part 85 may be in contact with any part of the outline of the main body part 80.

(B2) In the above-described embodiment, the support structure part 85 may be in contact with any position on the inner surface of the main body part 80. When the main body part 80 has a corner part that is convex inward, the support structure part 85 may be shaped on the inner side of the main body part 80 in such a way as to be in contact with the corner part.

(B3) In the above-described embodiment, a

plurality of support structure parts 85 separated from each other is shaped at positions corresponding to all the corner parts of the main body part 80. However, the support structure part 85 may be shaped at positions corresponding to some of the corner parts of the main body part 80 instead of all the corner parts.

(B4) In the above-described embodiment, the support structure part 85 has a shape extending along the vertical direction. However, when the side surface of the main body part 80 has a bent part, the support structure part 85 may have a part that is bent along the side surface shape of the main body part 80.

(B5) In the above-described embodiment, the first shaping material and the second shaping material are different materials, and the second shaping material and the third shaping material are the same material. However, for example, the first shaping material, the second shaping material, and the third shaping material may be the same material. In this case, the three-dimensional shaping device 100 may have one shaping unit 110. Also, the first shaping material, the second shaping material, and the third shaping material may be different shaping materials. In this case, the three-dimensional shaping device 100 has at least three shaping units 110.

(B6) In the above-described embodiment, the shaping unit 110 plasticizes the material with the flat screw 40. However, the shaping unit 110 may plasticize the material, for example, by rotating an in-line screw. The shaping unit 110 may plasticize a filament material with a heater.

### C. Other Aspects

The present disclosure is not limited to the above-described embodiments and may be implemented with various configurations without departing from the spirit and scope of the present disclosure. For example, technical features in the embodiments corresponding to technical features in aspects described below can be replaced or combined as appropriate in order to solve a part or all of the above-described problems or in order to achieve a part or all of the above-described effects. The technical features can be deleted as appropriate unless described as essential in the present specification.

(1) According to a first aspect of the present disclosure, a method for manufacturing a three-dimensional shaped object is provided. This manufacturing method includes: a first process of ejecting a first shaping material to shape a release layer on a stage; a second process of ejecting a second shaping material and stacking a shaped layer on the release layer to shape a main body part of a three-dimensional shaped object; and a third process of ejecting a third shaping material to shape a brim layer on the release layer, wherein the release layer and the brim layer are layers separated from the main body part shaped by the second process, and a corner part of the brim layer and the main body part come into contact with each other over a plurality of shaped layers.

According to this aspect, since the main body part and the brim layer are shaped on the release layer in such a way that the corner part of the brim layer and the main body part come into contact with each other over the plurality of shaped layers, the three-dimensional shaped object can be easily released from the stage while the occurrence of warping of the main body part is suppressed.

(2) In the above aspect, the brim layer may include a plurality of support structure parts separated from each other at positions corresponding to a plurality of corner parts of an outline of the main body part. According to this aspect, the warping of the main body part can be effectively suppressed.

(3) In the above aspect, the support structure part may have a quadrangular prism shape or a cylindrical shape.

(4) In the above aspect, a corner part of a side surface of the support structure part may be in contact with a corner part of an outline of the main body part. According to this aspect, since the contact area between the main body part and the brim layer is reduced, the brim layer can be easily released from the main body part while the influence of the brim layer on the appearance of the main body part is suppressed.

(5) In the above aspect, a height of the support structure part may be 5% or more of a height of the corner part of the main body part.

(6) In the above aspect, a height of the support

structure part may be a height corresponding to a height of the corner part of the main body part.

(7) In the above aspect, the main body part may have a hollow shape, and the main body part may have a groove along a stacking direction of the shaped layer on an inner surface of the main body part.

The present disclosure is not limited to the above method for manufacturing a three-dimensional shaped object and can be implemented according to various aspects such as a three-dimensional shaping system, a three-dimensional shaping device, a computer program, and a non-transitory tangible recording medium in which a computer program is recorded in a computer-readable manner.

What is claimed is:

1. A method for manufacturing a three-dimensional shaped object, the method comprising:
a first process of ejecting a first shaping material to shape a release layer on a stage;
a second process of ejecting a second shaping material and stacking a shaped layer on the release layer to shape a main body part of a three-dimensional shaped object; and
a third process of ejecting a third shaping material to shape a brim layer on the release layer, wherein
the release layer and the brim layer are layers separated from the main body part shaped by the second process, and
a corner part of the brim layer and the main body part come into contact with each other over a plurality of shaped layers.

2. The method for manufacturing a three-dimensional shaped object according to claim 1, wherein
the brim layer includes a plurality of support structure parts separated from each other at positions corresponding to a plurality of corner parts of an outline of the main body part.

3. The method for manufacturing a three-dimensional shaped object according to claim 2, wherein
the support structure part has a quadrangular prism shape or a cylindrical shape.

4. The method for manufacturing a three-dimensional shaped object according to claim 3, wherein
a corner part of a side surface of the support structure part is in contact with a corner part of an outline of the main body part.

5. The method for manufacturing a three-dimensional shaped object according to claim 2, wherein
a height of the support structure part is 5% or more of a height of the corner part of the main body part.

6. The method for manufacturing a three-dimensional shaped object according to claim 2, wherein
a height of the support structure part is a height corresponding to a height of the corner part of the main body part.

7. The method for manufacturing a three-dimensional shaped object according to claim 1, wherein
the main body part has a hollow shape, and
the main body part has a groove along a stacking direction of the shaped layer on an inner surface of the main body part.
